(19) United States
(12) Patent Application Publication
(10) Pub. No.: US 2026/0161379 A1
(43) Pub. Date: Jun. 11, 2026

(54) UPDATE PACKAGING FOR DISCONNECTED PRIVATE CLOUD

(71) Applicant: Hewlett Packard Enterprise Development LP, Spring, TX (US)

(72) Inventors: Tejaswi Bangalore Rajeevalochanam, Bangalore (IN); Sonu Sudhakaran, Bangalore (IN); Rakesh Lakshminarayana Rao, Bangalore (IN)

(21) Appl. No.: 19/044,498

(22) Filed: Feb. 3, 2025

(30) Foreign Application Priority Data
Dec. 11, 2024 (IN) 202441098046

(51) Int. Cl. G06F 8/65; G06F 8/71; G06F 11/3668; G06F 21/64

(52) U.S. Cl. CPC G06F 8/65; G06F 8/71; G06F 11/3688; G06F 21/64

(57) ABSTRACT

In certain examples, a method includes obtaining, from a schema and by a disconnected private cloud update packager, an information set corresponding to a set of updates for a disconnected private cloud; obtaining, based on the information set and by the disconnected private cloud update packager, the set of updates from one or more update locations; packaging, by the disconnected private cloud update packager, the set of updates as a disconnected private cloud update package comprising the set of updates, wherein the disconnected private cloud update package, when deployed in the disconnected private cloud, updates a plurality of components of the disconnected private cloud; and providing the disconnected private cloud update package to one or more entities that maintain disconnected private cloud instances.

### BACKGROUND

Computing resources (e.g., hardware resources, software resources) may be deployed as part of a cloud environment. Various components within a cloud environment may, from time to time, be updated, for example, with new versions of software, firmware, and the like.

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 shows a block diagram of a system for providing a disconnected private cloud update package in accordance with one or more examples disclosed herein;

FIG. 2 is a block diagram of a system for generating a disconnected private cloud update package, in accordance with one or more examples disclosed herein;

FIG. 3 illustrates an overview of an example method for generating and providing a disconnected private cloud update package, in accordance with one or more examples disclosed herein;

FIG. 4 illustrates a block diagram of a computing device, in accordance with one or more examples disclosed herein; and

FIG. 5 illustrates a block diagram of a computing device, in accordance with one or more examples disclosed herein.

### DESCRIPTION

The following disclosure provides many different examples for implementing different features. Specific examples of components and arrangements are described below to simplify the present disclosure. These are, of course, merely examples and are not intended to be limiting.

Entities may seek an environment of computing resources for performing various tasks, operations, activities, and the like, and/or in which various applications, services, and the like may be operated and/or provided. Such an environment may be referred to as a cloud environment. Resources in a cloud environment may be obtained, for example, from a cloud services provider, which may provide hardware resources, software resources, management services, and/or any other relevant components and/or services to be deployed as the cloud environment. In some circumstances, such entities may seek to retain at least some degree of control over such an environment by having at least some control of the physical computing resources (e.g., computing devices, network devices, storage devices, management devices, and the like) and/or logical resources (e.g., software, applications, services, container platforms, management techniques, and the like). An environment in which such an entity maintains such control may be referred to as a private cloud. In one or more examples, a private cloud is an environment in which all or any portion of physical and/or logical computing resources are managed, used, or otherwise maintained by a particular entity (e.g., a company) or set of entities and are intended for the use of the entity or set of entities that maintain the private cloud.

As an example, a particular entity may seek and acquire physical components, such as computing devices, networking equipment, storage devices, infrastructure components, and other components, such as management software, applications, services, other software, and the like from a provider of such resources, and deploy the resources at one or more physical sites as a private cloud. A private cloud may include external network connections (e.g., a connection to the Internet) through which a connection to an external entity, referred to herein as a cloud services provider or private cloud provider, may exist, and through which the private cloud provider may provide private cloud services such as management services, software updates, software lifecycle management services, device lifecycle management services, health monitoring, and the like. In other scenarios, a private cloud may be a disconnected private cloud, where the computing resources maintained by the entity exist at one or more physical locations, and are not connected to an external network, such as the Internet. In these scenarios, one or more of the locations may be connected via a private network controlled by the entity.

In one or more examples, a disconnected private cloud includes all or any portion of the various physical and other components that may be included in a connected private cloud. However, unlike a connected private cloud, a disconnected private cloud may not have a connection to a private cloud provider from which updates for the various components of the private cloud may be obtained and/or installed. Such updates may include, but are not limited to, updates for: server basic input/output system (BIOS), firmware for various server components (e.g., network interface cards, storage controllers, power supplies, management controllers, and the like), device drivers, network device firmware and other software (e.g., operating systems), storage device firmware and other software, private cloud platform software (e.g., user interface and management software for managing and/or accessing portions of a private cloud), services implemented within a private cloud (e.g., virtual machine as-a-service (VMaaS), bare metal as-a-service (BMaaS), hybrid cloud services, container services, and the like), network services, container services, identity management services (e.g., single sign-on services), monitoring services, observation services, migration services, backup services, file and object services, and the like.

In a connected private cloud (e.g., a private cloud with an external network connection to at least a private cloud provider), such updates may be developed on an on-going basis, and continuously deployed and integrated into the connected private cloud as the updates are released via the external network connection of the connected private cloud. However, such continuous delivery, deployment, and integration of updates is not possible for a disconnected private cloud, where no such external connection exists (e.g., when a private cloud is ‘air-gapped’). Thus, entities that deploy a disconnected private cloud may not receive updates for the various components of the disconnected private cloud in any coherent, cohesive, or predictable manner, which may cause the components of the disconnected private cloud to become outdated, lack updates for correcting software flaws, lack updates related to securing the disconnected private cloud, and/or require significant overhead and management to monitor, seek, obtain, and deploy updates as they are released frequently from a private cloud provider.

One or more examples disclosed herein address, at least in part, the above-described challenges of updating the various components of a disconnected private cloud by packaging, from time to time, a set of all updates that are relevant to a private cloud into a single update package, which may be provided to entities that have a disconnected private cloud, for deployment therein.

In one or more examples, any number of development teams may exist that develop any number of updates for all of the various components of a private cloud. Such updates may be developed on a continuous basis, with updates released for deployment to connected private clouds frequently (e.g., daily, multiple times a day, every other day, weekly, and the like). However, updating a disconnected private cloud at such a frequent pace may not be practical, or possible. In one or more examples, in order to provide such updates for a disconnected private cloud, a private cloud provider may establish a particular timing and cadence (e.g., every two months, every three months, every six months, and the like), such as a schedule, at which a current set of updates is obtained, packaged, tested, code-signed, and released for consumption by and deployment within disconnected private cloud environments.

In one or more examples, the various development teams that develop updates for components of a private cloud are made aware of the planned schedule for releasing a disconnected private cloud update package. In one or more examples, pursuant to that schedule, the various development teams may provide information about the latest available updates to a common location, such as, for example, a schema document that is configured to have a particular format, and in which the development teams may provide relevant information about their respective updates. Such information may include, but is not limited to, the name of the component, the name of the update, a version number of the update, metadata related to the updates, names of scripts for installing the updates, any dependencies that the updates may have, and the like. In one or more examples, the schema may be in a defined format that allows the schema to be automatically and programmatically assessed by a packager component to determine the updates therein, and any related information (e.g., required installation packages, libraries, release notes, manuals, and the like), and the locations from which such updates and other information may be obtained in order to generate a comprehensive package that includes the updates and other information. In one or more examples, the schema also includes, for each update, any dependency information that may exist. As an example, a first update to a particular version of a component may require that another component in the disconnected private cloud be at some minimum version. As another example, a particular update to a component may require a particular version of an installer, one or more specific libraries, and the like.

In one or more examples, a disconnected private cloud update packager may be configured to access the schema at a particular time in advance of a planned release of a disconnected private cloud update package, and to obtain a set of updates based on the information included therein. Such updates may include, but are not limited to, image files, firmware files, BIOS files, installation scripts, various dependency components, install bundles, package management bundles, tarballs, service software updates, and/or any other updates relevant to a private cloud. Such updates may be obtained from any number of locations, such as from one or more software repositories, directly from development teams, from one or more file servers, and the like,

In one or more examples, the disconnected private cloud update packager may package the set of obtained updates into a single package of any type (e.g., an image file packaged as a tarball). In one or more examples, the package may then be made available to one or more quality assurance (QA) teams, which may test the package by deploying it in a test private cloud environment, to identify and, if necessary, address any issues that are discovered during such a deployment. In one or more examples, once the QA team(s) approve of the package (e.g., when the number of issues discovered is zero or some minimum level of acceptability), the QA team(s) may provide an indication to the disconnected private cloud update packager that the package is ready for release.

In one or more examples, once the package is ready for release, the disconnected private cloud update packager may execute a signing process to verify the authenticity and integrity of the update package. In one or more examples, the signed update package may then be released, meaning the signed update package is made available to entities that maintain a disconnected private cloud. Such entities may be made aware of the update package using any suitable techniques for providing information, such as, for example, via an email notification. The update package may be made publicly available (e.g., on a website), or delivered privately to such entities. In order for the update package to be brought within a disconnected private cloud, the update package may be placed on some form of computer readable media (e.g., flash-based storage devices universal serial bus (USB) key), within a demilitarized zone network, and the like. In one or more examples, once an entity that maintains a disconnected private cloud becomes aware of and obtains an update package, the entity may deploy the update package within the disconnected private cloud at a time that is convenient for the entity

Certain examples disclosed herein may address challenges related to updating software, firmware, services, and the like for various components within a disconnected private cloud by creating an update package that includes all relevant updates to such an environment, and makes the update package available to be deployed within the disconnected private cloud. Collecting the various updates into a single update package, for which authenticity and integrity is verified via digitally signing the complete package, may allow entities that maintain a disconnected private cloud from having to individually update the various components of the disconnected private cloud and potentially disparate times, thereby reducing the cost and complexity of maintaining a properly updated disconnected private cloud.

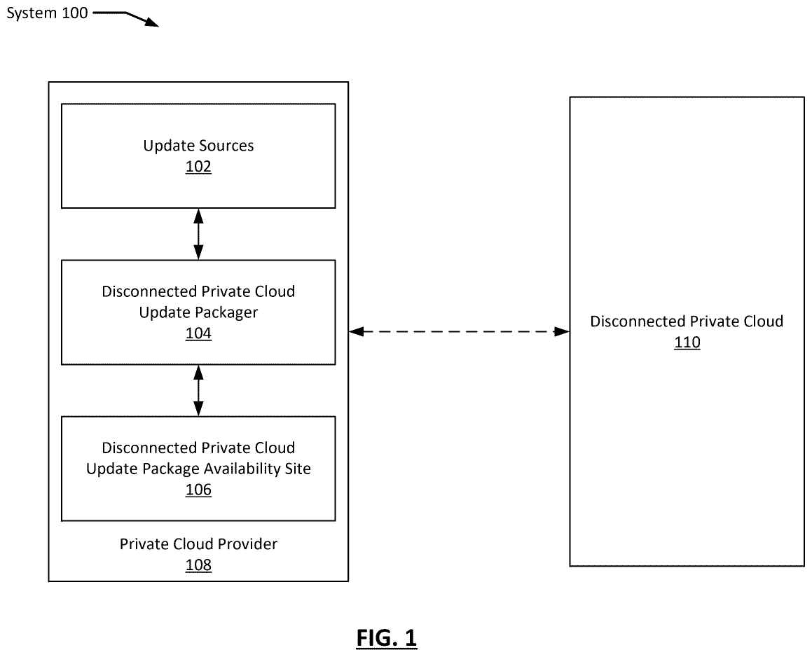

FIG. 1 shows a block diagram of a system 100 for providing a disconnected private cloud update package in accordance with one or more examples disclosed herein. As shown in FIG. 1, the system 100 includes a private cloud provider 108, which includes update sources 102, a disconnected private cloud update packager 104, and a disconnected private cloud update package availability site 106, and a disconnected private cloud 110. Each of these components is described below.

In one or more examples, a private cloud (e.g., the disconnected private cloud 110) is a cloud environment deployed for and use by one entity or a particular set of entities. In one or more examples, a cloud environment is a collection of compute resources (e.g., computing devices, network devices, storage devices, various types of software, and the like). As an example, a particular entity, such as a company, may seek to have a cloud environment that employees of the company use for various purposes and/or through which the company provides various services to users.

In some scenarios, an entity may choose to have a disconnected private cloud, such as the disconnected private cloud 110. In one or more examples, the disconnected private cloud 110 is a private cloud instance that does not have connection to any external networks, such as the Internet. In some examples, a disconnected private cloud 110 may be referred to as air-gapped, signifying the disconnection of the private cloud from external networks. In the example shown in FIG. 1, the disconnection of the private cloud is represented via the dashed line from the disconnected private cloud 110 and other components shown in FIG. 1. An entity may elect to implement a disconnected private cloud for any reason, such as for example, increased security and/or increased privacy within the disconnected private cloud 110. In some scenarios, the disconnected private cloud 110 may be operatively connected to a demilitarized zone (DMZ) network, which may in turn be operatively connected to one or more external networks, such as the Internet. In other scenarios, the disconnected private cloud 110 may be fully disconnected, with no direct or indirect connection to any devices outside the disconnected private cloud 110.

The disconnected private cloud 110 may include any amount of hardware resources, including, but not limited to, computing devices, network devices, storage devices, infrastructure components, and the like, each of which may include any number of sub-components (e.g., network interface cards, storage controllers, expansion cards, management controllers, light emitting devices, disk drives, and the like). Such devices, and components therein, may operate, at least in part, using components such as BIOS, firmware, and other software elements. Additionally, a private cloud may include any number of services, such as VMaaS services, BMaaS services, container services, micro-services, hybrid cloud services, monitoring services, operations services, management services, security services, network services, storage services, identity management services, and the like, which may be provided, for example, from a private cloud provider (e.g., the private cloud provider 108, discussed below). The disconnected private cloud 110 may also include any number of add on services and applications, such as, for example, migration services, backup services, file and object services, third-party applications, and the like. A collection of the aforementioned software elements, firmware elements, services, and the like, deployed within the disconnected private cloud 110, may be referred to herein as a set of private cloud components of a disconnected private cloud.

In one or more examples, all or any portion of the set of private cloud components deployed within the disconnected private cloud 110 may be provided to an entity that maintains a disconnected private cloud by the private cloud provider 108. The private cloud provider 108 may provide all or any portion of the hardware resources, services, user interfaces, applications, and the like of a disconnected private cloud 110, as well as the software and firmware corresponding to such components.

In one or more examples, the private cloud provider 108 may generate updates for all or any portion of a set of private cloud components. As an example, a private cloud provider may have any number of software and/or firmware development teams, which may continuously develop updates for firmware for various devices and components, software for various services, software for various applications, and the like. Such updates are often released frequently, for integration and deployment into connected private cloud instances, where a private cloud has an external network connection to at least the private cloud provider. Such updates may be provided via the external network connection for deployment within the connected private cloud. However, such continuous development and integration to update components of a connected private cloud are not possible for the disconnected private cloud 110, as, by design, the disconnected private cloud 110 has no external network connection to the private cloud provider 108.

In one or more examples, the aforementioned updates to a set of private cloud components are provided from any number of update sources 102. The update sources 102 may include any number of development teams that generate the updates, as well as any number of locations where such updates and related information may be stored, such as one or more repositories (e.g., git repositories), directories, folders, and the like. In one or more examples, as software, firmware, and the like are developed by development teams of the update sources 102, the updated components, any other software on which component updates depend, documentation related to the updates, and the like store the update materials in the various locations.

In one or more examples, because a disconnected private cloud is not configured to consume all updates developed by a private cloud provider (e.g., the private cloud provider 108), a disconnected private cloud update schedule may be made available to development teams of the update sources 102. Such a schedule may include, for example, any number of times (e.g., dates) at which the private cloud provider plans to release a disconnected private cloud update package to be provided to entities that have deployed a disconnected private cloud (e.g., the disconnected private cloud 110). Based at least in part on the disconnected private cloud update schedule, development teams of the update sources 102 may, at any time before such a release date (e.g., one month before, two weeks before, and the like), add information to a schema document, with such information being related to the particular updates that the development teams want to be included in the next release of the disconnected private cloud update package. In one or more examples, the schema may be a document that is in a consistent format, which may be programmatically assessed (e.g., by the disconnected private cloud update packager 104, discussed below) to obtain the information therein related to the various updates that are to be included in the disconnected private cloud update package. For each component update, the schema may include, but is not limited to, the name of the component, the name of the update, a version number of the update, metadata related to the updates, names of scripts for installing the updates, any dependencies that the updates may have, a location from which the update and related information may be obtained, and the like. Thus, in one or more examples, the schema, once updated by the various development teams, may represent a set of updates for a set of private cloud components, which may be ready to be packaged as a disconnected private cloud update package.

In one or more examples, the private cloud provider 108 includes the disconnected private cloud update packager 104. In one or more examples, the disconnected private cloud update packager 104 is any hardware (e.g., circuitry), or software executing on hardware, that is configured to access the aforementioned schema to obtain information about updates to a set of private cloud components, to obtain the updates and related information from one or more locations of the update sources 102, and to generate a disconnected private cloud update package. A disconnected private cloud update package may include, but is not limited to, image files, firmware files, BIOS files, installation scripts, various dependency components, libraries, installation bundles, package management bundles, tarballs, service software updates, and/or any other updates relevant to a private cloud.

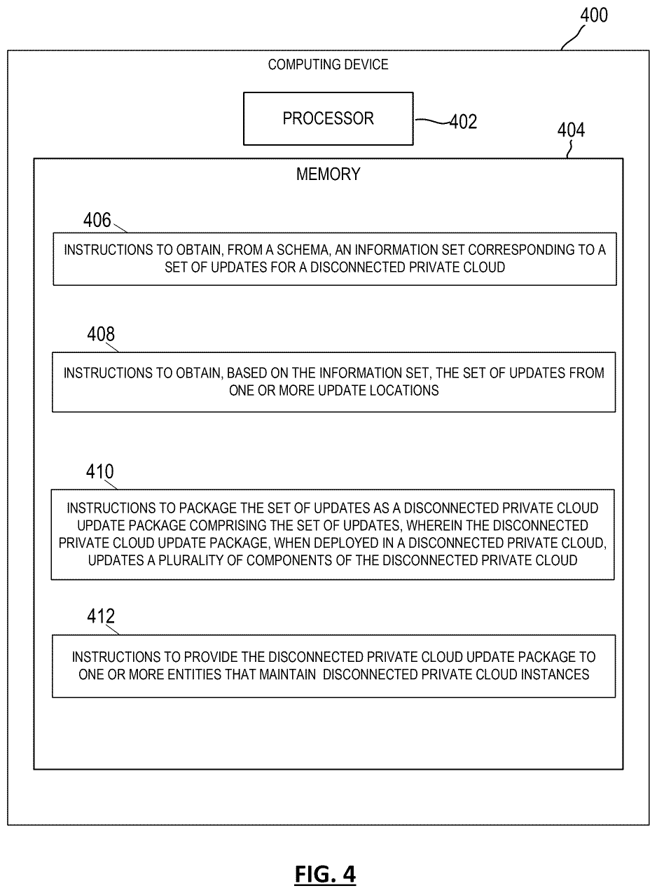

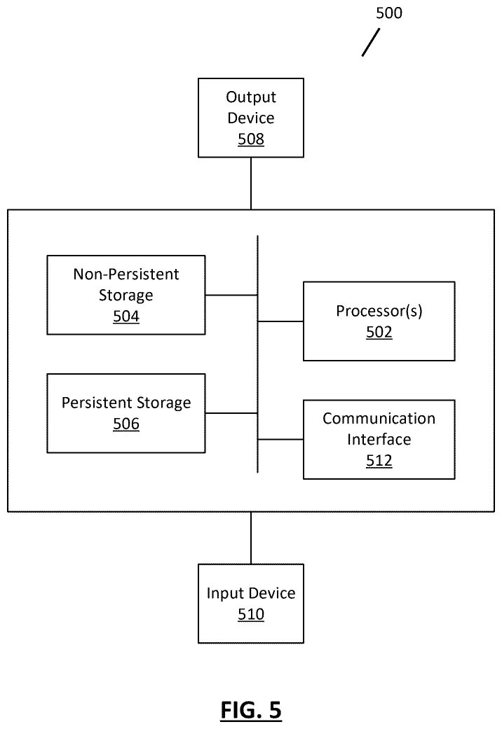

As an example, the disconnected private cloud update packager 104 may be a computing device. In one or more examples, as used herein, a computing device may be any single computing device, a set of computing devices, a portion of one or more computing devices, or any other physical, virtual, and/or logical grouping of computing resources. Non-limiting examples of a computing device are shown in FIG. 4 and FIG. 5, which are described below. In one or more examples, a computing device may be any device of any type that is configured to host all or any portion of one or more applications, microservices, clustered environment services, storage services, network services, and/or any other computing function, which may include executing instructions, performing operations, executing functions, performing computations, and the like.

In one or more examples, a computing device is any device, portion of a device, or any set of devices capable of electronically processing instructions and may include, but is not limited to, any of the following: one or more processors (e.g. components that include circuitry), memory (e.g., random access memory (RAM)), input and output device(s), non-volatile storage hardware (e.g., solid-state drives (SSDs), persistent memory (Pmem) devices, hard disk drives (HDDs)), one or more physical interfaces (e.g., network ports, storage ports), any number of other hardware components, and/or any combination thereof.

Examples of computing devices include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, any other type of storage device), a network device, a virtual machine, a virtualized computing environment, a logical container (e.g., for one or more applications), a container pod, an Internet of Things (IoT) device, an array of nodes of computing resources, a supercomputing device, a data center or any portion thereof, any combination of the aforementioned items, and/or any other type of computing device. As one of ordinary skill in the art will appreciate, any of the aforementioned examples of computing devices necessarily require at least some hardware components. As an example, a virtual machine, a container, and/or a container pod, when considered as a computing device herein, include the underlying hardware on which the virtual machine, container, and/or a container pod executes.

In one or more examples, the storage and/or memory of a computing device or system of computing devices may be and/or include one or more data repositories for storing any number of data structures storing any amount of data (e.g., information). In one or more examples, a data repository is any type of storage unit and/or device (e.g., a file system, database, collection of tables, RAM, hard disk drive, solid state drive, and/or any other storage mechanism or medium) for storing data. Further, the data repository may include multiple different storage units and/or devices. The multiple different storage units and/or devices may or may not be of the same type or located at the same physical location.

In one or more examples, any storage and/or memory of a computing device or system of computing devices may be considered, in whole or in part, as non-transitory computer readable mediums storing software and/or firmware, which, when executed by one or more processors, cause the one or more processors to perform operations (e.g., execution of one or more computer programs) in accordance with one or more examples disclosed herein.

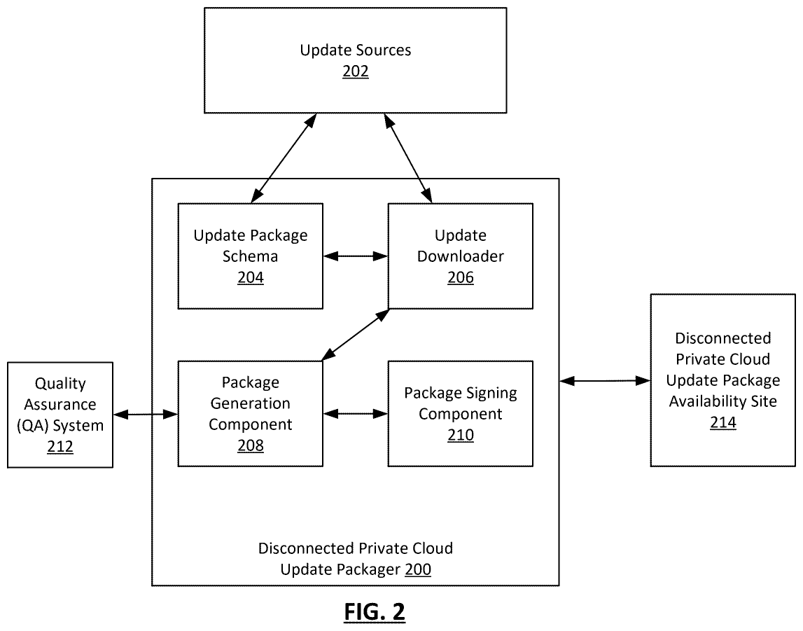

In one or more examples, the disconnected private cloud update packager 104 includes an artifact packager (e.g., a JFrog artifactory). An artifact may include, but is not limited to, any source code, compiled code, dependency resources, documentation, installers, container images, other software images, libraries, configuration files, and the like related to an update for a component of a private cloud, all or any portion of which may be provided by the one or more development teams of the update sources 102, included in a schema, and available in a location of the update sources 102. An artifact packager may be configured to obtain any number of artifacts, and to package the artifacts into a single package (e.g., an image file, a tarball, and the like) as a disconnected private cloud update package. In one or more examples, the disconnected private cloud update packager 104 is also configured to perform other tasks related to the disconnected private cloud update package, such as, for example, assigning a version number to the disconnected private cloud update package, providing or otherwise making the package available to one or more QA teams for testing, executing processes to digitally sign the disconnected private cloud update package after successful QA testing, making the disconnected private cloud update package available to entities that maintain a disconnected private cloud (e.g., releasing the disconnected private cloud update package), and/or notifying such entities of the availability of the disconnected private cloud update package (e.g., via a notification email). The disconnected private cloud update packager 104 is discussed further in the description of FIG. 2, below.

In one or more examples, the private cloud provider 108 includes the disconnected private cloud update package availability site 106. In one or more examples, the disconnected private cloud update package availability site 106 is any suitable location for releasing a disconnected private cloud update package. As an example, the disconnected private cloud update package availability site 106 may be a website, a file transfer protocol (FTP) site, and the like, that is available to at least one or more entities that maintain a disconnected private cloud, and is where the disconnected private cloud update package may be hosted and made available to such entities.

While FIG. 1 shows a particular configuration of devices and/or components, other configurations may be used without departing from the scope of examples described herein. Accordingly, examples disclosed herein should not be limited to the configuration of devices and/or components shown in FIG. 1.

FIG. 2 is a block diagram of a system for generating a disconnected private cloud update package, in accordance with one or more examples disclosed herein. As shown in FIG. 2, the system includes the update sources 202, the QA system 212, the disconnected private cloud update package availability site 214, and the disconnected private cloud update packager 200. In the example shown in FIG. 2, the disconnected private cloud update packager 200 includes an update package schema 204, an update downloader 206, a package generation component 208, and a package signing component 210. Each of these components is described below.

In one or more examples, the update sources 202 are the same as or substantially similar to the update sources 102 shown in FIG. 2 and discussed above. As such, the update sources 202 may include any number of development teams that develop updates for private cloud components, as well as update locations (e.g., software repositories) from which such updates may be obtained.

In one or more examples, the update sources 202 are operatively connected to various components of the disconnected private cloud update packager 200, as discussed further below. In one or more examples, the disconnected private cloud update packager 200 is the same as or substantially similar to the disconnected private cloud update packager 104 shown in FIG. 1 and discussed above. As such, in some examples, the disconnected private cloud update packager 200 may be a computing device. As an example, the disconnected private cloud update packager 200 may be a set of containers (e.g., executing on one or more computing devices) configured to, at least, assess the update package schema 204, obtain a set of private cloud updates via the update downloader 206 based on the updates found un the update package schema 204, package the updates as a disconnected private cloud update package using the package generation component 208, and digitally sign the disconnected private cloud update package via the package signing component 210.

In one or more examples, the update sources 202 are operatively connected to the update package schema 204 of the disconnected private cloud update packager 200. In one or more examples, the update package schema 204 is a document or set of documents that include information about updates to private cloud components. Specifically, in one or more examples, the update package schema 204 includes information about updates to be included in a disconnected private cloud update package. Such information may include, but is not limited to, the name of the component, the name of the update, a version number of the update, metadata related to the updates, names of scripts for installing the updates, any dependencies that the updates may have, a location from which the update and related information may be obtained, and the like. The update package schema 204 may be in any suitable format that may be assessed to obtain the update information therein, so that the various updates to be included in a disconnected private cloud update package may be obtained and packaged. In one or more examples, the update package schema 204 may be manually or automatically updated as development teams complete development of updates for private cloud components.

In one or more examples, the update package schema 204 is updated pursuant to a planned release schedule for the disconnected private cloud update package. As an example, a private cloud provider (e.g., the private cloud provider 108 of FIG. 1) may have a release schedule for releasing a new version of the disconnected private cloud update package once every three months. In such a scenario, the update package schema 204 may be required to be updated by the various development teams of the update sources 202 one month prior to a planned release date of the disconnected private cloud update package. In one or more examples, the update package schema 204, once updated by the various development teams, may represent a set of updates for a set of private cloud components, which may be ready to be packaged as a disconnected private cloud update package.

In one or more examples, the update sources 202 are also operatively connected to the update downloader 206 of the disconnected private cloud update packager 200. Specifically, as discussed above, the update sources 202 may include any number of repositories or other locations where updates for private cloud components are stored, and from which such updates may be obtained. In one or more examples, the update downloader 206 is configured to access such locations, and download the updates therefrom. In one or more examples, the update downloader 206 is configured to obtain the set of updates based at least in part on the information obtained from the update package schema 204. In one or more examples, the disconnected private cloud update packager 200 is configured to automatically assess the update package schema 204 at a particular time prior to a planned release of a disconnected private cloud update package, and, based on the information included in the update package schema 204 at that time, automatically obtain the updates via the update downloader 206.

In one or more examples, the disconnected private cloud update packager 200 includes the package generation component 208. In one or more examples, the package generation component 208 is any hardware, or software executing on hardware, that is configured to generate a disconnected private cloud update package using updates and any other relevant items obtained by the update downloader 206 based on the update package schema 204. The package generation component 208 may be configured to generate a package of updates for private cloud components in any suitable format for such a package (e.g., image file, tarball, and the like). The package generation component maybe configured, where necessary, to perform any decryption (e.g., of obtained updates) and/or encryption (e.g., of the disconnected private cloud update package, or any portion thereof). In one or more examples, the package generation component is configured to implement versioning for the disconnected private cloud update package. As an example, for a particular release, the disconnected private cloud update package may be generated as a version v1.0, and a subsequent release may be generated as version v1.1. Any suitable versioning scheme may be used without departing from the scope of examples disclosed herein.

In one or more examples, after the disconnected private cloud update package is generated by the package generation component 208, the disconnected private cloud update packager 200 is configured to provide or otherwise make the disconnected private cloud update package available to the QA system 212. In one or more examples, the QA system 212 is any set of resources that may be used to test the disconnected private cloud update package. As an example, one or more QA teams may maintain one or more test private cloud environments, into which the deployment of the disconnected private cloud update package may be tested. In some examples, all or any portion of the testing of the disconnected private cloud update package is automated. In other examples, all or any portion of the testing may be designed to mimic the experience that entities that maintain a disconnected private cloud would have when deploying the disconnected private cloud update package. As an example, the QA system 212 may include a test repository that hosts the disconnected private cloud update package, and the testing may include obtaining the disconnected private cloud update package onto some form of computer readable media (e.g., a USB key), and bringing the disconnected private cloud update package into a test disconnected private cloud for deployment therein.

In one or more examples, the QA system 212 performs testing of the disconnected private cloud update package to determine whether any issues exist with deploying the updates therein. In one or more examples, once it is determined that no issues exist, or a minimum acceptable level of issues exist, with deploying the updates using the disconnected private cloud update package, the QA system 212 may provide an indication of acceptability to the disconnected private cloud update packager 200. In one or more examples, based on such an indication, the disconnected private cloud update packager 200 may digitally sign the disconnected private cloud update package. The disconnected private cloud update packager 200 may sign the disconnected private cloud update package via the package signing component 210. In one or more examples, the package signing component 210 is any hardware, or software executing on hardware, that is configured to digitally sign the disconnected private cloud update package using any suitable signing technique. As an example, the package signing component may code sign the disconnected private cloud update package using a private key of the private cloud provider (e.g., the private cloud provider 108 of FIG. 1), so that a consumer of the disconnected private cloud update package may use a corresponding public key to verify the signature. The signing process may include using a digital certificate for additional verification. In one or more examples, the signing of the disconnected private cloud update package allows the authenticity (e.g., the package is from the private cloud provider and has not been altered) and integrity (e.g., the package has not been tampered with post-signing) of the disconnected private cloud update package to be ascertained.

In one or more examples, once the disconnected private cloud update package has been generated (e.g., by the package generation component 208), successfully tested (e.g., by the QA system 212), and signed (e.g., by the package signing component 210), the disconnected private cloud update packager 200 may release the disconnected private cloud update package. In one or more examples, the disconnected private cloud update package may be released using any suitable technique for releasing software, or otherwise making software available to entities that maintain a disconnected private cloud. As an example, the disconnected private cloud update packager 200 may put the disconnected private cloud update package in a particular storage location, and a website available to entities that maintain a disconnected private cloud may be updated to include a link to the location where the disconnected private cloud update package is stored. Such a storage location and website may be collectively referred to as the disconnected private cloud update package availability site 214.

In one or more examples, the disconnected private cloud update packager 200, or any other suitable component of the private cloud provider, may be configured to provide a notification of the availability of the disconnected private cloud update package to entities that maintain a disconnected private cloud. As an example, such entities may be subscribed to receive emails about the availability of the disconnected private cloud update package, and, thus, may receive a notification via email when a new version of the disconnected private cloud update package is made available. In one or more examples, after being notified of the availability of the new version of the disconnected private cloud update package, an entity that has a disconnected private cloud may obtain the disconnected private cloud update package, which may, for example, be put onto some form of removable media to be brought into the disconnected private cloud, or be put into a DMZ network area corresponding to the disconnected private cloud, and then deployed within the disconnected private cloud.

While FIG. 2 shows a particular configuration of devices and/or components, other configurations may be used without departing from the scope of examples described herein. Accordingly, examples disclosed herein should not be limited to the configuration of devices and/or components shown in FIG. 2.

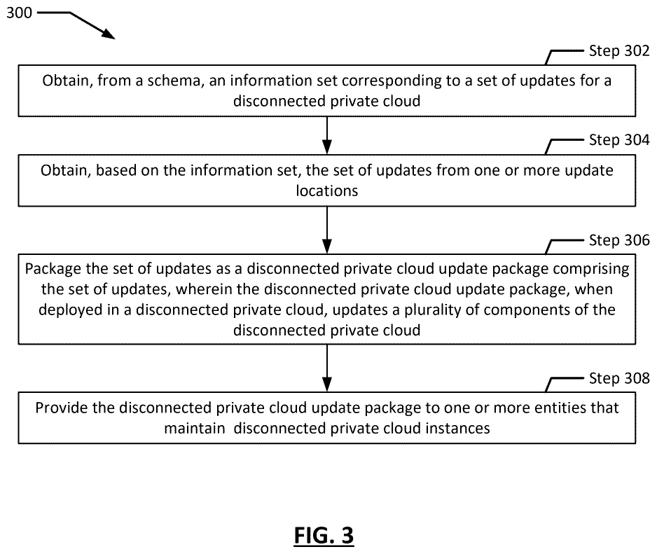

FIG. 3 illustrates an overview of an example method for generating and providing a disconnected private cloud update package, in accordance with one or more examples disclosed herein.

The method 300 may be performed, at least in part, by one or more devices and/or components of a private cloud provider (e.g., the private cloud provider 108 of FIG. 1). As such, all or any portion of the method 300 may be performed, for example, by a disconnected private cloud update packager (e.g., the disconnected private cloud update packager 104 of FIG. 1, the disconnected private cloud update packager 200 of FIG. 2).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3 and/or steps not shown in FIG. 3.

In Step 302, the method 300 includes obtaining, from a schema (e.g., the update package schema 204 of FIG. 2), an information set corresponding to a set of updates for a disconnected private cloud. In one or more examples, the information set is obtained by a disconnected private cloud update packager (e.g., the disconnected private cloud update packager 104 of FIG. 1, the disconnected private cloud update packager 200 of FIG. 2). In one or more examples, the schema includes information about any number of updates for private cloud components, all or any portion of which may be included in the information set. Such information may include, at least, for each update, a name of the update, a version number of the update, and a location from which the update and any other relevant information may be obtained. The schema may also include any amount of additional information corresponding to each update, such as, for example, any dependencies related to the update. In one or more examples, the schema is updated by various software development teams to include the information set corresponding to the set of updates pursuant to a planned release schedule associated with a disconnected private cloud update package.

In Step 304, the method 300 includes obtaining, based on the information set, the set of updates from one or more update locations. The set of updates may be obtained, for example, by a disconnected private cloud update packager (e.g., the disconnected private cloud update packager 104 of FIG. 1, the disconnected private cloud update packager 200 of FIG. 2). In one or more examples, an update location is any location (e.g., of the update sources 102 of FIG. 1 or the update sources 202 of FIG. 2) where updates for private cloud components, and any other relevant information (e.g., installer packages, installation scripts, various dependencies, libraries, and the like) may be obtained, such as, for example, one or more software repositories. In one or more examples, the disconnected private cloud update packager is configured to obtain the set of updates at a time prior to a planned release of a disconnected private cloud update package.

As an example, various software development teams may be provided a deadline for updating the aforementioned schema with the information set corresponding to the set of updates for a disconnected private cloud, and the disconnected private cloud update packager may be configured to obtain the set of updates anytime after such a deadline passes. In one or more examples, the set of updates may include, but is not limited to, the various updates, and any other information related to such updates, that may be obtained from the one or more update locations.

In one or more examples, the set of updates may include, but is not limited to, one or more private cloud infrastructure updates (e.g., firmware and/or software updates for computing devices, network devices, storage devices, and the like of a disconnected private cloud), one or more private cloud service software updates (e.g., VMaaS updates, BMaaS updates, network service updates, storage service updates, management service updates, container service updates, monitoring service updates, security service updates, backup service updates, migration service updates, file and object service updates, and the like), and/or one or more private cloud application updates (e.g., updates for any applications deployed within a disconnected private cloud that are provided by the private cloud provider).

In Step 306, the method 300 includes packaging the set of updates as a disconnected private cloud update package comprising the set of updates, wherein the disconnected private cloud update package, when deployed in a disconnected private cloud, updates a plurality of components of the disconnected private cloud. The disconnected private cloud update package may include all or any portion of the updates and other information included in the set of updates obtained in Step 304. The disconnected private cloud update package may be packaged using any suitable technique for generating a package. The disconnected private cloud update package may be generated in any suitable package format (e.g., an image file, a tarball, and the like). In one or more examples, packaging the set of updates as a disconnected private cloud update package may include assigning a version number to the disconnected private cloud update package.

In one or more examples, although not shown in FIG. 3, the disconnected private cloud update package, once generated, may be provided to a QA system (e.g., the QA system 212 of FIG. 2) to be tested. In one or more examples, after being successfully tested (e.g., when zero or an acceptable minimum number of issues exist with deploying the package in a private cloud environment), the disconnected private cloud update packager may receive an indication from the QA system that the disconnected private cloud update package has passed QA testing. In one or more examples, based at least in part on receiving such an indication, the disconnected private cloud update packager may digitally sign the disconnected private cloud update package using any suitable signing technique

In Step 308, the method 300 includes providing the disconnected private cloud update package to one or more entities that maintain disconnected private cloud instances. As an example, a signed disconnected private cloud update package may be provided by a disconnected private cloud update packager (e.g., the disconnected private cloud update packager 104 of FIG. 1, the disconnected private cloud update packager 200 of FIG. 2). In one or more examples, providing the disconnected private cloud update package may include posting the disconnected private cloud update package in a suitable storage location, and updating a user interface (e.g., a website) accessible to entities that maintain a disconnected private cloud to include a link to the disconnected private cloud update package, so that such entities may download or otherwise obtain the disconnected private cloud update package. In one or more examples, providing the disconnected private cloud update package to the one or more entities may include transmitting a notification of any suitable type (e.g., an email) to the one or more entities, to alert the one or more entities of the availability of the new disconnected private cloud update package.

In one or more examples, although not shown in FIG. 3, once the disconnected private cloud update package has been provided by the disconnected private cloud update packager, and obtained by an entity that maintains a disconnected private cloud, the disconnected private cloud update package may be deployed within the disconnected private cloud instance maintained by the entity to update the various private cloud components therein.

FIG. 4 illustrates a block diagram of a computing device 400, in accordance with one or more examples disclosed herein. The computing device 400 may be an example of the various computing devices (e.g., the disconnected private cloud update packager 104 of FIG. 1, the disconnected private cloud update packager 200 of FIG. 2) described above and/or of the computing device 500, described below. As discussed above in the descriptions of FIG. 1, FIG. 2, and FIG. 3, the computing device 400 may be used to implement all or any portion of the various components shown in FIG. 1 and/or FIG. 2 and described above and/or to perform all or any portion of the method 300 shown in FIG. 3 and described above.

The computing device 400 may include one or more processors 402 and memory 404. The memory 404 may include a non-transitory computer-readable medium that stores programming for execution by one or more of the one or more processors 402. In this implementation, one or more modules within the computing device 400 may be partially or wholly embodied as software for performing any functionality described in this disclosure. The computing device 400 may be, for example, configured to perform the method 300 shown in FIG. 3 and described above, by executing instructions included in the memory 404 and executed by the one or more processors 402.

For example, the memory 404 may include instructions 406 to obtain, from a schema, an information set corresponding to a set of updates for a disconnected private cloud (e.g., as described above in reference to Step 302 of FIG. 3).

For example, the memory 404 may include instructions 408 to obtain, based on the information set, the set of updates from one or more update locations (e.g., as described above in reference to Step 304 of FIG. 3).

For example, the memory 404 may include instructions 410 to package the set of updates as a disconnected private cloud update package comprising the set of updates, wherein the disconnected private cloud update package, when deployed in a disconnected private cloud, updates a plurality of components of the disconnected private cloud (e.g., as described above in reference to Step 306 of FIG. 3).

For example, the memory 404 may include instructions 412 to provide the disconnected private cloud update package to one or more entities that maintain disconnected private cloud instances (e.g., as described above in reference to Step 308 of FIG. 3).

FIG. 5 illustrates a block diagram of a computing device, in accordance with one or more examples of this disclosure. As discussed above, examples described herein may be implemented, at least in part, using computing devices, and the computing device 500 shown in FIG. 5 may be such a computing device. For example, all or any portion of the components shown in FIG. 1 (e.g., private cloud provider 108, the update sources 102, the disconnected private cloud update packager 104, the disconnected private cloud update package availability site 106) and/or FIG. 2 (e.g., the update sources 202, the disconnected private cloud update packager 200, the update package schema 204, the update downloader 206, the package generation component 208, the package signing component 210, the QA system 212, the disconnected private cloud update package availability site 214) may be implemented, at least in part using a computing device such as the computing device 500, and may include all or any portion of the components of the computing device 500 shown in FIG. 5 and described below.

In one or more examples, a computing device (e.g., the computing device 500) is any device, portion of a device, or any set of devices capable of electronically processing instructions and may include, but is not limited to, any of the following:
one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. In some examples, a computing device (e.g., the computing device 500) may include any number of heterogeneous processors.

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be a central processing unit (CPU), a multi-core CPU, an application specific integrated circuit (ASIC), a graphics processing unit (GPU), a data processing unit (DPU), a tensor processing units (TPU), an associative processing unit (APU), a vision processing units (VPU), a quantum processing unit (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, a network device, or a processing device to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, operative connection, and variations thereof, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A system, comprising:
one or more processors; and
one or more non-transitory computer readable media storing instructions which, when executed by the one or more processors, cause the one or more processors to:
obtain, from a schema and by a disconnected private cloud update packager, an information set corresponding to a set of updates for a disconnected private cloud;
obtain, based on the information set and by the disconnected private cloud update packager, the set of updates from one or more update locations;
package, by the disconnected private cloud update packager, the set of updates as a disconnected private cloud update package comprising the set of updates, wherein the disconnected private cloud update package, when deployed in the disconnected private cloud, updates a plurality of components of the disconnected private cloud; and
provide the disconnected private cloud update package to one or more entities that maintain disconnected private cloud instances.

2. The system of claim 1, wherein:
the schema is updated to include the information set pursuant to a release schedule associated with the disconnected private cloud update package, and
the disconnected private cloud update packager is configured to access the schema to obtain the information set prior to a planned release of the disconnected private cloud update package.

3. The system of claim 1, wherein:
the information set comprises update version numbers, update dependencies, and the one or more update locations corresponding to the set of updates, and
the disconnected private cloud update package is assigned a version number after being packaged.

4. The system of claim 1, wherein, after packaging the set of updates as the disconnected private cloud update package and before providing the disconnected private cloud update package to the one or more entities that maintain the disconnected private cloud instances, the instructions further cause the one or more processors to:
provide, by the disconnected private cloud update packager, the disconnected private cloud update package to a quality assurance (QA) system for testing; and
receive, from the QA system, an indication that the disconnected private cloud update package was successfully tested.

5. The system of claim 4, wherein, after receiving the indication that the disconnected private cloud update package was successfully tested, the instructions further cause the one or more processors to:
digitally sign the disconnected private cloud update package.

6. The system of claim 1, wherein, before providing the disconnected private cloud update package to one or more entities that maintain disconnected private cloud instances, the instructions further cause the one or more processors to:
transmit a notification indicating availability of the disconnected private cloud update package to the one or more entities.

7. The system of claim 1, wherein the set of updates comprises one or more of a private cloud infrastructure update, a private cloud service software update, and a private cloud application update.

8. A computer-implemented method, comprising:
obtaining, from a schema and by a disconnected private cloud update packager, an information set corresponding to a set of updates for a disconnected private cloud;
obtaining, based on the information set and by the disconnected private cloud update packager, the set of updates from one or more update locations;
packaging, by the disconnected private cloud update packager, the set of updates as a disconnected private cloud update package comprising the set of updates, wherein the disconnected private cloud update package, when deployed in the disconnected private cloud, updates a plurality of components of the disconnected private cloud; and
providing the disconnected private cloud update package to one or more entities that maintain disconnected private cloud instances.

9. The computer-implemented method of claim 8, wherein:
the schema is updated to include the information set pursuant to a release schedule associated with the disconnected private cloud update package, and
the disconnected private cloud update packager is configured to access the schema to obtain the information set prior to a planned release of the disconnected private cloud update package.

10. The computer-implemented method of claim 8, wherein:
the information set comprises update version numbers, update dependencies, and the one or more update locations corresponding to the set of updates, and
the disconnected private cloud update package is assigned a version number after being packaged.

11. The computer-implemented method of claim 8, further comprising, after packaging the set of updates as the disconnected private cloud update package and before providing the disconnected private cloud update package to the one or more entities that maintain the disconnected private cloud instances:
providing, by the disconnected private cloud update packager, the disconnected private cloud update package to a quality assurance (QA) system for testing; and
receiving, from the QA system, an indication that the disconnected private cloud update package was successfully tested.

12. The computer-implemented method of claim 11, further comprising, after receiving the indication that the disconnected private cloud update package was successfully tested:
digitally signing the disconnected private cloud update package.

13. The computer-implemented method of claim 8, further comprising, before providing the disconnected private cloud update package to one or more entities that maintain disconnected private cloud instances:
transmitting a notification indicating availability of the disconnected private cloud update package to the one or more entities.

14. The computer-implemented method of claim 8, wherein the set of updates comprises one or more of a private cloud infrastructure update, a private cloud service software update, and a private cloud application update.

15. A non-transitory computer-readable medium storing programming for execution by one or more processors, the programming comprising instructions to:
obtain, from a schema and by a disconnected private cloud update packager, an information set corresponding to a set of updates for a disconnected private cloud;
obtain, based on the information set and by the disconnected private cloud update packager, the set of updates from one or more update locations;
package, by the disconnected private cloud update packager, the set of updates as a disconnected private cloud update package comprising the set of updates, wherein the disconnected private cloud update package, when deployed in the disconnected private cloud, updates a plurality of components of the disconnected private cloud; and
provide the disconnected private cloud update package to one or more entities that maintain disconnected private cloud instances.

16. The non-transitory computer-readable medium of claim 15, wherein:
the schema is updated to include the information set pursuant to a release schedule associated with the disconnected private cloud update package,
the disconnected private cloud update packager is configured to access the schema to obtain the information set prior to a planned release of the disconnected private cloud update package,
the information set comprises update version numbers, update dependencies, and the one or more update locations corresponding to the set of updates, and
the disconnected private cloud update package is assigned a version number after being packaged.

17. The non-transitory computer-readable medium of claim 15, wherein the programming comprises further instructions to, after packaging the set of updates as the disconnected private cloud update package and before providing the disconnected private cloud update package to the one or more entities that maintain the disconnected private cloud instances:
provide, by the disconnected private cloud update packager, the disconnected private cloud update package to a quality assurance (QA) system for testing; and
receive, from the QA system, an indication that the disconnected private cloud update package was successfully tested.

18. The non-transitory computer-readable medium of claim 17, wherein the programming comprises further instructions to, after receiving the indication that the disconnected private cloud update package was successfully tested:
digitally sign the disconnected private cloud update package.

19. The non-transitory computer-readable medium of claim 15, wherein, before providing the disconnected private cloud update package to one or more entities that maintain disconnected private cloud instances, the instructions further cause the one or more processors to:
transmit a notification indicating availability of the disconnected private cloud update package to the one or more entities.

20. The non-transitory computer-readable medium of claim 15, wherein the set of updates comprises one or more of a private cloud infrastructure update, a private cloud service software update, and a private cloud application update.
